(19) United States
(12) Patent Application Publication
(10) Pub. No.: US 2010/0287500 A1
(43) Pub. Date: Nov. 11, 2010

(54) METHOD AND SYSTEM FOR DISPLAYING CONFORMAL SYMBOLOGY ON A SEE-THROUGH DISPLAY

(75) Inventors: Stephen Whitlow, St. Louis Park, MN (US); Randy Gene Hartman, Plymouth, MN (US); Roland Miezianko, Plymouth, MN (US); Trish Ververs, Ellicott City, MD (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/273,387

(22) Filed: Nov. 18, 2008

(51) Int. Cl. G09G 5/00; G06F 3/048

(52) U.S. Cl. 715/810; 345/633

(57) ABSTRACT

A method is provided for displaying symbology on a see-through display device in an environment with at least one real-world object. The method includes selecting the at least one real-world object; selecting symbology to display with the at least one real-world object; and conformally displaying the symbology with the at least one real-world object.

### TECHNICAL FIELD

The present invention generally relates to display devices such as head-up displays (HUDs), near-to-eye (NTE) displays, augmented reality (AR) displays, and other types of see-through displays, and more particularly relates to methods and systems for dynamic generation and display of conformal symbology on the see-through displays.

### BACKGROUND

Modern vehicles, such as aircraft, often include head-up displays (HUDs) that project various symbols and information onto a transparent display, or image combiner, through which a user (e.g., the pilot) may simultaneously view the external world. Traditional HUDs incorporate fixed image combiners located above the instrument panel on the windshield of the aircraft, or directly between the windshield and the pilot's head.

More recently, “head-mounted” HUDs have been increasingly developed that utilize image combiners, such as near-to-eye (NTE) displays, coupled to the helmet or headset of the pilot that moves with the changing position and angular orientation of the pilot's head. NTE and other types of see-through displays have also been used on the ground within an augmented reality (AR) system to enhance a user's perception of, and interaction with, the real-world by overlaying information on objects in the world. As one example, the see-through displays may be used by dismounted soldiers to enhance situational awareness by overlaying tactical information, such as likely enemy locations and the position of rally points.

However, in some cases, traditional NTE or AR displays have difficulty in accurately displaying symbology in the correct location of the contact analog in the real world, or possibly obscure the view or the real-world image. Additionally, traditional NTE, HUD, and AR displays tend to clutter a user's view.

Accordingly, it is desirable to provide improved methods and systems for displaying symbology on a see-through display. Furthermore, other desirable features and characteristics of the present invention will become apparent from the subsequent detailed description of the invention and the appended claims, taken in conjunction with the accompanying drawings and this background of the invention.

### BRIEF SUMMARY

In accordance with an exemplary embodiment, a method is provided for displaying symbology on a see-through display device in an environment with at least one real-world object. The method includes selecting the at least one real-world object; selecting symbology to display with the at least one real-world object; and conformally displaying the symbology with the at least one real-world object.

In accordance with another exemplary embodiment, a display system includes a display unit with a see-through screen configured to view at least one real-world object; a input device configured to select the at least one real-world object; and a processing unit configured to generate display commands based on the selection of the input device such that the display unit conformally displays symbology associated with the at least one real-world object.

In accordance with yet another exemplary embodiment, a method is provided for displaying symbology on a see-through display device in an environment with at least one real-world object. The method includes selecting the at least one real-world object with a user input device; selecting symbology to display relative to the at least one real-world object with the user input device; conformally orienting the symbology relative to the at least one real-world object; and displaying the symbology on the display device.

### BRIEF DESCRIPTION OF THE DRAWINGS

The present invention will hereinafter be described in conjunction with the following drawing figures, wherein like numerals denote like elements, and wherein:

FIG. 1 is a schematic block diagram of a display system in accordance with an exemplary embodiment;

FIG. 2 is a view rendered by the display system of FIG. 1 in accordance with an exemplary embodiment; and

FIG. 3 is a flow chart of a method for displaying conformal symbology in accordance with an exemplary embodiment.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, and brief summary or the following detailed description.

Broadly, exemplary embodiments discussed herein include methods and systems for dynamic generation and presentation of conformal symbology. In one embodiment, the display system is a head-up display (HUD) device, an augmented reality (AR) device, a near-to-eye (NTE) device, or other type of see-through device. The display system may display symbology that conforms to real-world objects such that the situational awareness of the user is enhanced without inducing clutter in their tactical view. The symbology may include labels or outlines selected by the user and displayed on real-world objects that have been designated by the user.

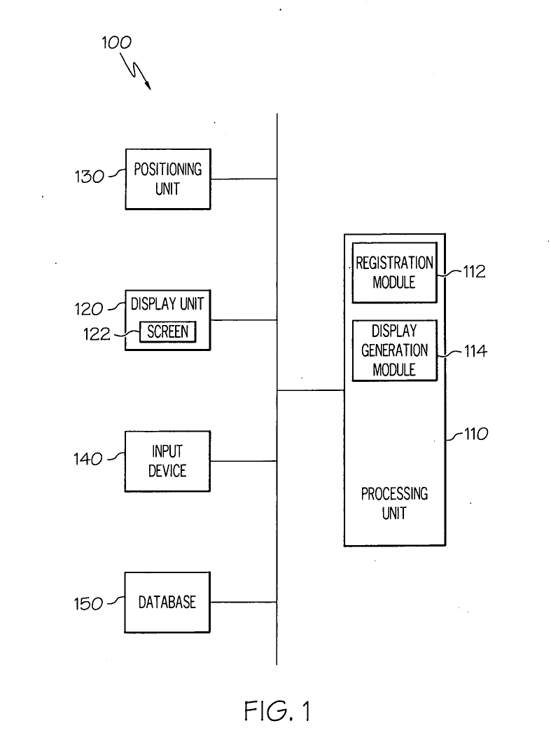

FIG. 1 is a schematic block diagram of a display system 100 in accordance with an exemplary embodiment. The display system 100 includes a processing unit 110, a display unit 120, a positioning unit 130, a user input unit 140, and a database 150. The processing unit 110, display unit 120, positioning unit 130, user input device 140, and database 150 can be physically collocated at a common location or distributed across a number of locations. In one embodiment, all of the components are carried or worn by a user. Additionally, although the components are described as separate units or devices, they may be integrated with one another or form part of a larger unit.

Generally, and as described in further detail below, the processing unit 110 is configured to receive inputs and to generate display commands based on the inputs such that the display system 100 selectively displays symbology that conforms to real-world objects. The processing unit 110 may be any one of numerous known general-purpose controller, circuit, or application specific processor that operates in response to program instructions, such as field programmable gate arrays (FPGAs), application specific integrated circuits (ASICs), discrete logic, microprocessors, microcontrollers, and digital signal processors (DSPs), or combinations thereof. The processing unit 110 may include on-board RAM and on-board ROM, and the program instructions that control the processing unit 110 may be stored in either or both the RAM and the ROM. For example, the operating system software may be stored in the ROM, whereas various operating mode software routines and various operational parameters may be stored in the RAM. Moreover, the RAM and/or the ROM may include instructions stored thereon for carrying out the methods and processes described below, although other storage schemes may be implemented. Additional functions of the processing unit 110 will be discussed in greater detail below.

The processing unit 110 includes one or more modules for more specialized functions, including a registration module 112 and a display generation module 114. The registration module 112 is configured to ascertain the location, position, and/or orientation of a real-world object such that symbology may be accurately registered with the object. Any suitable mechanism for registering objects may be used, including video analytics, which uses a sensor source to create an image and define the characteristics and location of the real world objects by selecting specific image features, performing image segmentation and image registration. As an example, the characteristics of an object may include latitude, longitude, and altitude, as well as yaw, pitch, and roll (among other representations). Various cameras, sensors, lasers, and/or any type of imaging may be used to assist the registration process. The registration module 112 may also include an eye motion detector to detect movement of the eye of the user relative to the user's head and various types of hardware, such as inertial sensors, to detect movements of the user's head such that the exact position of the user and their viewing angle relative to the designated object may be ascertained. The registration process may also use data from database 150, including look-up tables, recognition and tracking data, and template matching. The display generation module 114 receives inputs from the other components of the display system 100 and generates suitable display signals for rendering images on the display unit 120.

The display unit 120 is coupled to the processing unit 130 and generally includes a display screen 122 configured to display various images and data in graphic, iconic, and/or textual formats (i.e., symbology) based on display commands generated by the processing unit 130. In one embodiment, the display unit 120 is a see-through display unit, such as a HUD unit or an NTE display unit that displays computer generated symbology to result in an optical view of a real-world scene enhanced by the computer generated symbology. The display unit 120 may be implemented using any one of numerous types of displays suitable for rendering image and/or text data in a format viewable by a user, such as a cathode ray tube (CRT) displays, a LCD (liquid crystal display), or a TFT (thin film transistor) display.

In one embodiment, the display unit 120 includes a headset configured to be removably worn by an individual user, such as for example, a dismounted soldier. In another exemplary embodiment, the display unit 120 is mounted in a vehicle such as a truck. The display unit 120 may further include earphones and a microphone for audio communication. Generally, the display unit 120 is configured such that the display screen 122 is positioned directly in front of the user during operation. In one embodiment, the display screen 122 is a substantially transparent plate such as an image combiner.

The positioning unit 130 is coupled to the processing unit 110 and is configured to determine the location of the user and provide inputs to the processing unit 110 such that the conformal symbology is accurately displayed by the display system 100. The positioning unit 130 may also determine the orientation of the user, particularly the line-of-sight, and any change in the same. As such, the positioning unit 130 may include a Global Positioning Satellite (GPS) system, an automatic direction finder (ADF), inertial measuring unit, inertial angular rate sensor, magnetic sensors, ultrasound sensors, optical sensors, and/or a compass. For example, the positioning unit 130 may include a map, camera, LIDAR, LARAR, radar, sonar, or any other suitable device for obtaining details about a real-world object. Additionally, the positioning unit 130 may work in conjunction with the registration module 112 to ascertain movements (i.e., position and angular orientation) of the user's head, the display unit 120 as a whole, and/or the display screen 122.

The database 150 is coupled to the processing unit 110 and stores data for producing the computer generated symbology to be combined with the real-world environment. The database 150 may include both 2D and 3D location and orientation data for real-world objects, including terrain.

The user input device 140 is configured to receive input from a user and, in response to user input, supply command signals to the display system 100. The input device 140 may include any one of, or combination of, various known user interface devices including, but not limited to, a cursor control device (CCD), such as a mouse, a trackball, or joystick, and/or a keyboard, one or more buttons, switches, or knobs. The input device 140 may include an augmentation added to a rifle or data glove and/or eye tracking and selection capability. As will be discussed in further detail below, the input device 140 is configured to select an object from the real-world and the symbology type to be displayed with that object.

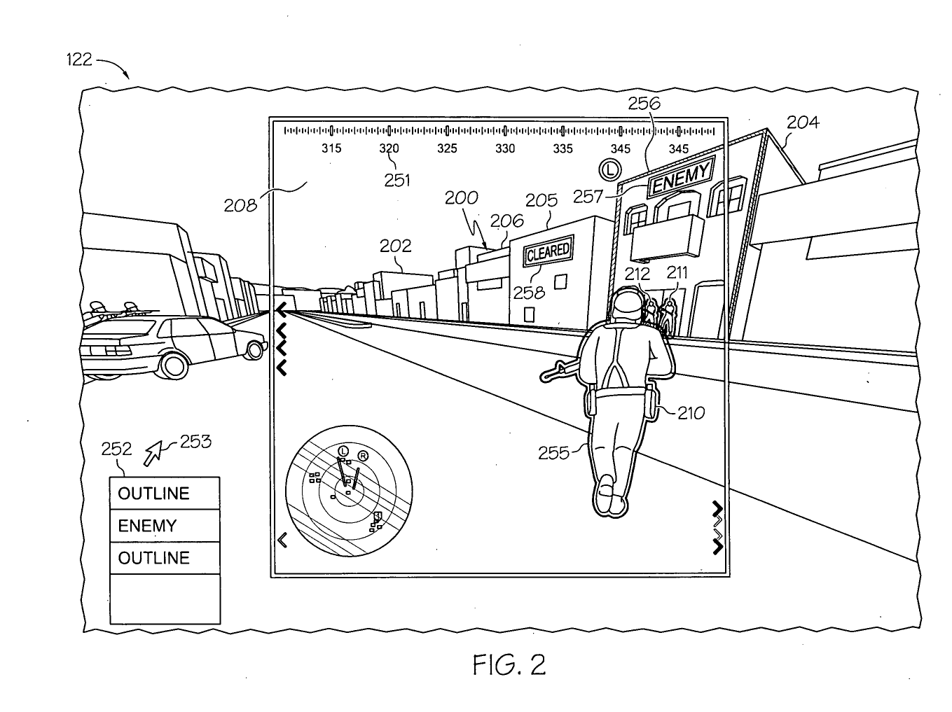

As noted above, during an exemplary operation, the display system 100 is worn by the user or arranged in front of the user such that the display screen 122 is positioned directly in front of at least one of the user's eyes. FIG. 2 is a view rendered on the display screen 122 of the display system 100 of FIG. 1 in accordance with an exemplary embodiment and will now be described in conjunction with FIG. 1.

The display screen 122 generally shows a first image 200 and a second image 250. In the depicted embodiment, the first image 200 is an underlying, “real-world” image that is at least representative of the user's first person view, i.e., the user is looking through the display screen 122. Although FIG. 2 illustrates the view of a soldier user, exemplary embodiments are applicable to various types of users. The first image 200 includes features such as a terrain portion 202 with buildings 204-206, a sky portion 208, and people 210-212. As noted above, in this exemplary embodiment, the display screen 122 is an image combiner, the first image 200 is simply the user's actual view of the physical terrain. In another exemplary embodiment, the display screen 122 may be, for example, an LCD display, and the first image 200 may be a computer-generated image (e.g., synthetic vision).

Still referring to FIG. 2, the second image 250 is displayed over the first image 200. The second image 250 includes various “symbology” features 251-258, including non-linked symbology 251-254 and linked symbology 255-258. The symbology 251-258 on the user's display screen 122 may be accessible by corresponding display systems for other users, such as fellow soldiers. Generally, linked symbology 251-254 corresponds to a particularly location, terrain object, building, person, geo-referenced item, and the like, while the non-linked symbology 251-254 does not. In the depicted exemplary embodiment, the non-linked symbology 251-254 includes selection symbology such as a pointer 253 and menu 252, which may form part of the user input device 140. The non-linked symbology 251-254 may further include a 2D-plan view 254 and an orientation indicator 251.

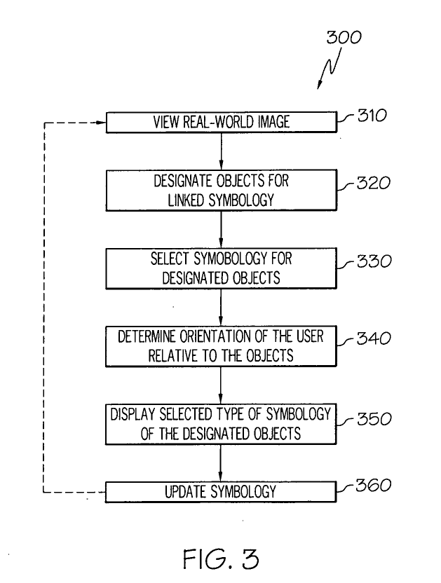

As briefly discussed above, symbology 251-258, particularly the linked symbology 255-258, may enhance or augment real-world objects. As an example, the linked symbology 255-258 includes a person marker 255 that marks or identifies a person in the user's view, such as a fellow soldier. The person marker 255 can be conformal to enhance the situational awareness of the user, and can convey information about the person marked. For example, the color or texture of the person marker 255 can indicate the identity of the soldier. The linked symbology 255-258 further includes a building marker 256 that overlays a designated or selected building (e.g., building 204). The building marker 256 may enhance the situational awareness of the user relative to the building 204. In the depicted embodiment, the building marker 256 is a conformal outline of the building 204. The linked symbology 255-258 may further include label 257 on building 204 and label 258 on building 205. The labels 257, 258 may convey information to the user about the nature and/or content of the respective building 204, 205. For example, the label 258 on building is “cleared,” thereby indicating that the building 205 is safe, and the label 257 on building 204 is “enemy,” thereby indicating that the building 204 is associated with or contains an enemy, target, or the like. Like marker 256, the labels 257, 258 are conformal, which conveys pertinent information while minimizing visual clutter. As described in further detail below, the linked symbology 255-258 may stay associated with the respective object or person as the object, person, and/or user moves. Although some examples of the types of symbology are illustrated in FIG. 2, any suitable symbology may be used. For example, symbology can be added to enhance natural terrain, such as outlining a valley between two mountains. One exemplary method 300 for generating an image on the display screen 122, such as that shown in FIG. 2, will now be described additionally with reference to the flow chart of FIG. 3.

In a first step 310 of the method 300, the user views the first image 250, i.e., the real-world view, through the display screen 122 of the display system 100. The system 100 may provide some non-linked symbology, such as a 2D-plan view 254 and an orientation indicator 251.

In a second step 320, objects are designated for linked symbology 255-258. In the embodiment depicted by FIG. 2, the soldier 210 and the buildings 204-206 are designated for linked symbology 255-258. The objects can be designated in any number of ways, including automatic selection, such as automatically designating fellow soldiers to be linked on the display screen 122. Alternatively, the items can be designated by another user or a command base. However, in one exemplary embodiment, the linked symbology 255-258 may be designated by the user. In other words, the user selects the objects to be enhanced. As one example, in this depicted embodiment, the user selects the buildings 204, 205 and indicates that he wants symbology displayed over those buildings 204, 205. The user selection can be made, for example, with the input device 140 by “clicking” on the designated building 204, 205 with pointer 253.

In a third step 330, appropriate symbology is selected for the designated object. The symbology selection can be automatic, such as the box 255 on soldier 210 in FIG. 2. Additionally, the symbology selection can be selected by the user. For example, the user may manipulate the pointer 253 with the input device 140 and select the desired type of symbology from menu 252. The user can click and drag the selection from the menu onto the appropriate object. As an example shown in FIG. 2, the user may select “cleared” from menu 252 with pointer 253 and drag the “cleared” label onto building 205. Additionally, the “enemy” label and outline selections from the menu 252 may be selected for building 204. In an alternative embodiment, the menu 252 may be omitted and the type of symbology may be selected by another mechanism, such as pushing a particular button on the user input device 140.

In a fourth step 340, the system 100 determines the orientation of the user relative to the objects selected for symbology. As discussed above, the positioning unit 130 can determine the location and orientation of the user. As also discussed above, the registration module 130 may include mechanisms for determining the location and orientation of the selected objects. In one embodiment, the registration module 112 includes video analytics that can determine the position, orientation, and other characteristics of the object based on the view from the user. Other components may also assist in this step, including data from other users, data from the database 140, and data from sources such as satellite images. Video analytics can determine the position, orientation, and other characteristics of the object based on the user's view by accurately segmenting image range data. Segmentation algorithms are essential to execute these higher level tasks by performing 3D modeling, registration, and object recognition. An algorithm for extracting smooth non-planar connected segments accomplishes the basic segmentation task. Another algorithm merges and registers segmented images, resulting in coherent segments corresponding to objects of interests in the larger scene viewed by the user.

In a fifth step 350, the system 100 displays the selected type of symbology on the designated objects. Based on orienting step 140, the system 130 may conformally display the symbology on the object. In other words, the symbology is properly registered and aligned with the real-world objects. As an example, in the depiction of FIG. 2, the labels 257, 258 and outline 256 conform to the respective building 204, 205. In a sixth step 360, the system 100 may update or refresh as necessary, such as when the user and/or objects move, or after a predetermined amount of time. In this case, the system 100 may track the designated objects such that the symbology is accurately displayed even after movement, or the user may repeat the steps above to designate new objects and/or symbology.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for displaying symbology on a see-through display device in an environment with at least one real-world object, the method comprising the steps of:
selecting the at least one real-world object;
selecting symbology to display with the at least one real-world object; and
conformally displaying the symbology with the at least one real-world object.

2. The method of claim 1, wherein the step of selecting the at least one real-world object includes selecting the at least one real-world object with a user input device.

3. The method of claim 1, wherein the step of selecting symbology includes selecting at least one of a symbol or a textual label.

4. The method of claim 3, wherein the step of conformally displaying includes placing the at least one of the symbol or textual label on the at least one real-world object.

5. The method of claim 1, wherein the step of selecting symbology includes selecting an outline.

6. The method of claim 1, wherein the step of selecting symbology includes orienting at least one of an outline or a symbol relative to the at least one real-world object.

7. The method of claim 1, wherein the step of conformally displaying includes using video analytics.

8. The method of claim 1, wherein the step of conformally displaying includes aligning the symbology with the at least one real-world object.

9. The method of claim 1, wherein the step of conformally displaying includes conformally displaying the symbology on a HUD.

10. The method of claim 1, further comprising determining the position of a user; and determining the orientation of the at least one real-world object relative to the position of the user.

11. A display system comprising:
a display unit with a see-through screen configured to view at least one real-world object;
a input device configured to select the at least one real-world object; and
a processing unit configured to generate display commands based on the selection of the input device such that the display unit conformally displays symbology associated with the at least one real-world object.

12. The display system of claim 11, further comprising a user input device coupled to the processing unit and configured to select the at least one real-world object.

13. The display system of claim 11, wherein the symbology includes at least one of an outline, a symbol, or a label.

14. The display system of claim 13, wherein processing unit is configured to place the at least one of the outline, symbol, or label on the at least one real-world object.

15. The display system of claim 11, wherein the symbology includes an outline.

16. The display system of claim 11, wherein processing unit is configured to orient at least one of an outline, a symbol or a label relative to the at least one real-world object.

17. The display system of claim 11, wherein the processing unit is further configured to perform video analytics on the at least one real-world object.

18. The display system of claim 11, wherein processing unit is configured to align the symbology with the at least one real-world object.

19. The display system of claim 11, further comprising a positioning unit coupled to the processor and configured to determine the position of a user relative to the at least one real-world object.

20. A method for displaying symbology on a see-through display device in an environment with at least one real-world object, the method comprising the steps of:
selecting the at least one real-world object with a user input device;
selecting symbology to display relative to the at least one real-world object with the user input device;
conformally orienting the symbology relative to the at least one real-world object; and
displaying the symbology on the display device.
